(19) United States
(12) Patent Application Publication
(10) Pub. No.: US 2007/0031718 A1
(43) Pub. Date: Feb. 8, 2007

(54) Fuel cell power generation system

(76) Inventors: Hidekazu Fujimura, Mito (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/500,351

(22) Filed: Aug. 8, 2006

(30) Foreign Application Priority Data
Aug. 8, 2005 (JP) 2005-228999

(51) Int. Cl. H01M 8/04; H01M 8/06

(52) U.S. Cl. 429/34; 429/19; 429/20; 429/17

(57) ABSTRACT

A fuel cell power generation system includes a hydrogen gas separator between a fuel gas feed unit and a fuel cell, and a circulation passage and a circulation blower for conveying an anode exhaust gas to the inlet of the hydrogen gas separator. The system is so configured as to convey a mixed gas of the anode exhaust gas and the fuel gas to the hydrogen gas separator via the circulation blower, and separated hydrogen gas is fed to the fuel cell.

### CLAIM OF PRIORITY

The present application claims priority from Japanese application serial no. 2005-228999, filed on Aug. 8, 2005, the content of which is hereby incorporated by reference into this application.

### FIELD OF THE INVENTION

The present invention relates to fuel cell power generation systems using hydrogen gas as a fuel.

### BACKGROUND OF THE INVENTION

Fuel cells realize energy saving, clean exhaust gas, and high energy efficiency and thereby have been received attention as possible candidates to solve environmental issues typified by air pollution caused by exhaust gases from, for examples, automobiles, and global warming caused by carbon dioxide.

Fuel cell power generation systems are energy conversion systems of feeding hydrogen gas (fuel gas) and air (oxidizing gas) to a fuel electrode (anode) and an air electrode (cathode) and of causing an electrochemical reaction so as to convert chemical energy to electrical energy. The electrochemical reaction does not yield carbon dioxide (CO₂) and exhaust gas containing detrimental substances but water alone.

The hydrogen gas, however, should be improved in its storage, transportation, and cost, in order to be widely used as the fuel. The hydrogen gas has been conventionally generally prepared by subjecting a hydrocarbon to steam reforming reaction. Thus, fuel cell power generation systems for domestic stationary use include a package of a reformer and a fuel cell, and use kerosene or town gas as the fuel.

Hydrogen separation technologies are being adopted so as to improve the generation efficiency of fuel cell power generation systems using such fossil fuels as raw material fuels.

For example, hydrocarbons such as town gas and liquefied petroleum gas (LPG) are used for power generation systems for domestic stationary use. In these systems, a hydrogen separation membrane is arranged in a reforming catalyst unit so as to separate hydrogen gas to thereby increase the hydrogen concentration and improve the hydrogen generation. The hydrogen separation membrane herein also acts to remove carbon monoxide to thereby improve the power generation efficiency, because carbon monoxide adversely affects the performances of the fuel cell (see, for example, Japanese Unexamined Patent Application Publication (JP-A) No. Hei 07-57758).

Proton-exchange membrane fuel cell (PEFC or PEM) power generation systems using pure hydrogen as a fuel are mainly intended to be mounted in vehicles. In these systems, a hydrogen separation membrane is arranged at the outlet of the cell to remove impurity gas and water generated in the cell node system. Unreacted hydrogen separated from the fuel electrode (anode) exhaust gas is returned to the inlet of the fuel electrode. Thereby hydrogen gas is effectively uses and the fuel economy (power generation efficiency) is improved (see, for example, Japanese Unexamined Patent Application Publication (JP-A) No. 2005-108698).

The technique disclosed in JP-A No. Hei 07-57758, however, fails to consider to effectively use unreacted hydrogen contained in the fuel electrode exhaust gas (anode exhaust gas), in contrast to the technique disclosed in JP-A No. 2005-108698, although the former technique may improve the power generation efficiency due to improved hydrogen concentration in the fuel gas.

In contrast, the technique of removing impurities from the fuel electrode exhaust gas discharged from the cell outlet and of recirculating a hydrogen-enriched gas to the cell inlet, as disclosed in JP-A No. 2005-108698, fails to consider to improve the hydrogen concentration in and to remove impurities from the fuel gas used upstream of the cell, in contrast to the technique disclosed in JP-A No. Hei 07-57758. The technique lacks the consideration to eliminate the effects of the composition of the fuel gas, such as an unsuitable composition or a composition containing an undesirable gas for the cell, at any time on startup and during operations.

A possible solution to solve the above-mentioned problems is the combination of these conventional techniques. Specifically, the resulting fuel cell power generation system includes two hydrogen separators in the fuel gas feed system upstream of the cell and in the fuel electrode exhaust gas discharge system downstream of the cell, respectively. This technique, however, causes new problems. For example, the technique requires two hydrogen separators, and this causes an increased cost. In addition, of such separators, those using separation membranes or fine porous articles generally require the control of the gas pressure, such as pressurization, and this causes a complicated process of controlling the pressure.

### SUMMARY OF THE INVENTION

An object of the present invention is to provide a fuel cell power generation system that can always remove detrimental substances and maintain a high hydrogen concentration in response to change in fuel gas composition and to contamination of impurities upstream of the fuel cell, can simultaneously recover unreacted hydrogen in the fuel cell outlet and recirculate the recovered hydrogen to the cell inlet, has a simple configuration, and can be easily operated.

A fuel cell power generation system of the present invention comprises a fuel cell being so configured as to feed a supply gas containing hydrogen gas to a fuel electrode, oxidize the supply gas, and discharge the residual gas as an exhaust gas. The supply gas comprises a mixed gas of a fuel gas containing hydrogen gas and all or part of the exhaust gas. The system further comprises a hydrogen gas separator having the function of separating hydrogen gas from the other gas, and is so configured as to feed the supply gas to the fuel electrode through the hydrogen gas separator.

The present invention further provides a method of operating a fuel cell, comprising the steps of:

mixing a fuel gas conveyed from a fuel feed unit with an exhaust gas discharged from a fuel electrode of a fuel cell;

pressurizing the resulting mixed gas and feeding the pressurized mixed gas to a unit for separating hydrogen gas so as to separate hydrogen gas; and

feeding the separated hydrogen gas to the fuel electrode of the fuel cell.

In addition and advantageously, the present invention provides a method for operating a fuel cell power generation system. The fuel cell power generation system comprises a fuel feed unit, a hydrogen gas separator, and a fuel cell comprising a fuel electrode, wherein an exhaust gas from the fuel cell has an impurity gas concentration higher than that of a fuel gas fed from the fuel gas feed unit. The method comprises the steps of:

mixing the exhaust gas with the fuel gas so as to allow the resulting mixed gas to have an impurity gas concentration lower than that of the exhaust gas;

conveying the mixed gas to the hydrogen gas separator to thereby separate hydrogen gas; and

feeding the separated hydrogen gas to the fuel electrode of the fuel cell.

According to a power generation system of the present invention, impurity gases detrimental to the cell, such as impurity gas contained in the fuel gas upstream from the fuel cell and/or impurity gas contained in the recirculated gas, can be eliminated effectively, and a high-concentration hydrogen gas can be fed to the cell at anytime including startup of operation and during operations. Additionally, an operation having a high utilization rate of the fuel can be continuously carried out. The power generation system can have a high generation efficiency and can be simplified in the configuration.

### BRIEF DESCRIPTION OF THE DRAWINGS

FIG. 1 is a schematic diagram illustrating the configuration of a fuel cell power generation system as an embodiment of the present invention (Embodiment 1).

FIG. 2 is a schematic diagram illustrating a modification of the configuration of the fuel cell power generation system as the embodiment of the present invention (Embodiment 1).

FIG. 3 is a schematic diagram illustrating the configuration of a fuel cell power generation system as another embodiment of the present invention (Embodiment 2).

FIG. 4 is a schematic diagram illustrating the configuration of a fuel cell power generation system as yet another embodiment of the present invention (Embodiment 3).

FIG. 5 is a schematic diagram illustrating the configuration of a fuel cell power generation system as still another embodiment of the present invention (Embodiment 4).

FIG. 6 is a schematic diagram illustrating the configuration of a fuel cell power generation system as another embodiment of the present invention (Embodiment 5).

FIG. 7 is a schematic diagram illustrating the structure of a hydrogen gas separator for use in the fuel cell power generation systems according to the present invention.

### DESCRIPTION OF THE PREFERRED EMBODIMENTS

A fuel cell power generation system according to an embodiment of the present invention is a solid polymer electrolyte fuel cell comprising a multilayer structure of single cells, each of single cells comprises a fuel electrode (anode) for oxidizing hydrogen gas; an air electrode (cathode) for reducing oxygen gas; and a solid polymer electrolyte membrane arranged between the fuel electrode and the air electrode.

The fuel cell system according to this embodiment has a fuel cell comprising a fuel inlet and an exhaust outlet. The fuel inlet serves to feed a gas containing hydrogen gas as a feed gas to the fuel electrode. The exhaust outlet serves to discharge the supply gas passed through the fuel electrode as an exhaust gas.

The supply gas is a mixed gas of the exhaust gas and a fuel gas comprising a hydrogen-enriched gas supplied from, for example, a hydrogen cylinder or a reformer.

The mixed gas comprises hydrogen gas and impurity gas other than hydrogen gas, and is thereby passed through a hydrogen gas separator having the function of separating hydrogen gas from another gas, and is fed to the fuel electrode as the supply gas.

The hydrogen gas separator comprises a hydrogen separation membrane comprising a ceramic having micropores on the order of nanometers, and is so configured as to pass a gas through the hydrogen separation membrane to thereby separate hydrogen gas from impurity gas. Accordingly, if the supply gas to be treated contains the impurity gas in a high concentration, the hydrogen gas separator does not effectively separate hydrogen gas from the impurity gas. Hydrogen gas in the fuel gas is consumed after passing through the fuel electrode, and the resulting exhaust gas has a relatively high concentration of the impurity gas and a relatively low concentration of the hydrogen gas. Therefore, the exhaust gas is mixed with the fuel gas having a high hydrogen gas concentration and having a low impurity gas concentration, and the resulting mixed gas is passed through the hydrogen gas separator according to the present invention. This effectively realizes efficient separation of hydrogen gas from the impurity gas.

The pressure of the mixed gas is set depending on the pressure of the exhaust gas and the pressure of the fuel gas. In this connection, a pressure sensor is preferably arranged upstream from the hydrogen gas separator. The pressure sensor detects the pressure of the mixed gas passing through the hydrogen gas separator, and the pressure of the mixed gas is then adjusted within a suitable range for the hydrogen gas separator so as to efficiently separate hydrogen gas from another gas. By satisfying this, hydrogen can be easily and efficiently separated from the impurity gas, and a feed gas enriched in hydrogen gas can be fed to the fuel electrode.

The present invention will be illustrated in further detail with reference to several specific embodiments of the fuel cell power generation systems according to the present invention and with reference to the attached drawings.

### Embodiment 1

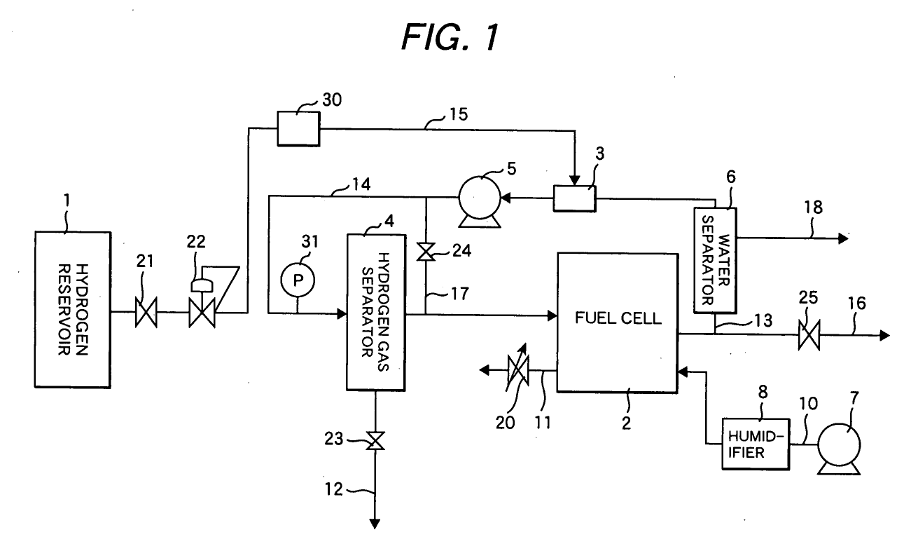

FIG. 1 is a schematic diagram illustrating the configuration of a fuel cell power generation system as an embodiment of the present invention (first embodiment). The fuel cell power generation system according to the first embodiment comprises a hydrogen reservoir 1, a fuel cell 2, a mixer 3, a hydrogen gas separator 4, and a circulation blower 5. The hydrogen reservoir 1 serves as a fuel feed unit and stores a fuel gas (anode gas) containing hydrogen gas at a high pressure. The fuel cell 2 generates power by using hydrogen gas in the fuel gas as a fuel for power generation. The mixer 3 serves to mix an exhaust gas discharged from the fuel cell 2 with the fuel gas. The hydrogen gas separator 4 separates hydrogen gas from a gas mixture discharged from the mixer 3. The circulation blower 5 pressurizes the gas mixture and conveys the pressurized gas mixture gas to the hydrogen gas separator 4.

The operation of the fuel cell power generation system illustrated in FIG. 1 will be described below.

The air, from which dust has been removed typically by an air filter (not shown), is compressed by an air feeder 7 and is conveyed to a humidifier 8 via an air-piping 10. The air humidified by the humidifier 8 is fed to an air electrode (cathode) inlet of the fuel cell 2. The air electrode inlet of the fuel cell 2 is provided with an air-pressure regulator 20, and the pressure of the air electrode is regulated by the degree of opening of the pressure regulator 20 and by the driving force of the air feeder 7. The air-pressure regulator 20 discharges the exhaust air to outside of the system via an air exhaust pipe 11.

The fuel gas containing hydrogen gas fed from the hydrogen reservoir 1 is regulated to a predetermined operation pressure by an on-off valve 21 and a pressure regulator 22, is controlled to a predetermined flow rate by a flow-rate controller 30, and is fed to the mixer 3 via a fuel feed piping 15.

The exhaust gas discharged from the fuel electrode outlet of the fuel cell 2 is conveyed to a water separator 6 via an exhaust gas circulation piping 13. Entrained water is separated from the exhaust gas, and is discharged to the outside of the system via a drain exhaust tube 18. Incidentally the entrained water in the exhaust gas is derived from humidified air and water produced as a result of a cell reaction, and it undergoes condensation in the inside pathway of the fuel cell 2. The exhaust gas discharged from the water separator 6 is fed to the mixer 3 via the exhaust gas circulation piping 13. The exhaust gas is mixed with the fuel gas in the mixer 3. The mixed gas is conveyed to the hydrogen gas separator 4 by the action of the circulation blower 5 arranged in a mixed gas piping 14. The hydrogen gas separator 4 comprises, for example, a porous membrane having micropores capable of allowing hydrogen to pass through. The mixed gas is separated into hydrogen gas and a secondary gas other than hydrogen gas. The system comprises a pressure sensor 31 arranged upstream from the hydrogen gas separator 4 for optimizing the hydrogen separation performance. Depending on the sensed pressure, the pressure regulator 22 and the driving force of the circulation blower are controlled so that the mixed gas is in the optimum pressure for the hydrogen gas separator 4. Unnecessary gas components such as inert gas and gas components detrimental to the fuel cell have been removed from the mixed gas as a result of separation, and the separated hydrogen gas has a high hydrogen concentration of substantially 100%. The hydrogen gas is fed to the fuel cell 2, in which hydrogen is consumed as a result of power generation in the fuel cell 2, and is discharged as an exhaust gas from the fuel electrode outlet of the fuel cell 2. The exhaust gas contains unreacted hydrogen gas, water, inert gas, and other impurity gases, as described above.

The secondary gas containing inert gas and other unnecessary or detrimental components, which is separated in the hydrogen gas separator, is discharged to outside the system continuously or intermittently by an on-off valve 23 via an exhaust pipe 12, according to the flow rate of the gas passing through the hydrogen gas separator 4 and the pressure of the gas sensed by the pressure sensor 31.

A residual gas in a purge piping 16 is discharged to outside by opening and closing a purge valve 25 to control the circulation flow rate and pressure of the mixed gas piping on operation startup and on operation stop. The discharged residual gas is diluted with the air and discharged from the system (not shown).

The system further comprises a bypass piping 17 and a bypass valve 24. The bypass piping 17 is used for bypassing the hydrogen gas separator 4 and serves to feed another gas than hydrogen gas, such as nitrogen gas, to the fuel cell by opening the bypass valve 24. This configuration is intended, for example, to feed another gas than hydrogen gas, such as nitrogen gas, to the fuel electrode during a stop of operation.

The system according to the first embodiment can prevent the cell from deteriorating, because the impurity gas and detrimental components contained in the exhaust gas from the fuel electrode outlet and in the fuel gas in the hydrogen reservoir 1, respectively, can be removed from upon startup of operation. Furthermore, as the fuel gas at the inlet of the fuel cell has a high hydrogen gas concentration, the hydrogen gas partial pressure in the fuel electrode is increased, and thereby the cell voltage is improved. In addition, unreacted hydrogen gas in the exhaust gas from the fuel electrode outlet is always circulated, and fresh hydrogen gas has only to be fed to the cell in an amount corresponding to the hydrogen consumed as a result of the cell reaction. Thus, substantially 100% of the fuel (hydrogen gas) can be utilized, and the generation efficiency is improved.

The system can have a simplified configuration, because only one hydrogen gas separator 4 is used to separate hydrogen from two different gases, i.e., the exhaust gas and the fuel gas. In addition, the system is capable of increasing the gas pressure so as to achieve the hydrogen gas separation and of circulating the exhaust gas by only one circulation blower 5, because the fuel gas and the exhaust gas are mixed, and the resulting mixed gas is conveyed to the blower 5 which serves to perform the above exhaust gas circulation and pressurization for the hydrogen gas separation. This also contributes to the simplification of the system.

High-purity hydrogen gas as the fuel gas from the hydrogen reservoir 1E is mixed with the exhaust gas, and the mixed gas is conveyed to the hydrogen gas separator 4. Therefore, even if a gas detrimental or inhibitory to the cell performance, such as nitrogen, water, or hydrocarbon, finds its way into the exhaust gas, the detrimental (inhibitory) gas contained in the exhaust gas is diluted with high-purity hydrogen gas into a lower concentration. The hydrogen gas after separation thereby has a concentration of such detrimental gas much lower than that in a conventional system having a hydrogen gas separator at the outlet of a cell. Thus, the cell is prevented from deteriorating in performance and can have a longer lifetime.

Furthermore, even if the ratio of another gas than hydrogen gas in the fuel gas from the hydrogen reservoir 1 increases or even if a detrimental gas to the fuel cell finds its way into the fuel gas, such other gas and detrimental gas can be eliminated in the hydrogen gas separator 4 before fed to the fuel cell 2. Thus, hydrogen gas containing less impurities can be fed to the fuel cell at any time including startup of operation, and the fuel cell can have high reliability.

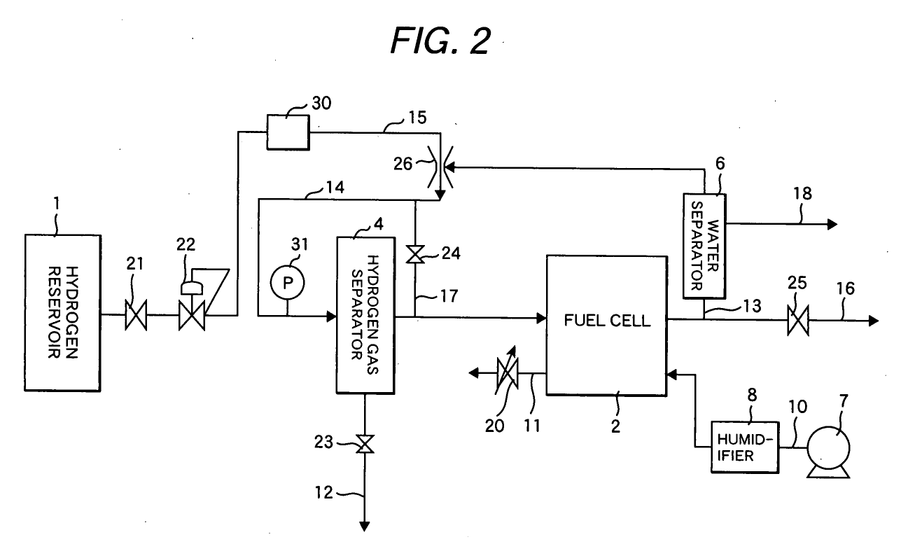

FIG. 2 illustrates a system as a modification of the system shown in FIG. 1. The hydrogen reservoir 1 of the modified system is a high-pressure hydrogen reservoir, and the system comprises an ejector 26 instead of the mixer 3 and the circulation blower 5. The fuel gas containing hydrogen gas is fed from the hydrogen reservoir 1, is controlled to a predetermined operation pressure by an on-off valve 21 and a pressure regulator 22, and fed to a nozzle of the ejector 26. The ejector 26 takes in the exhaust gas from an exhaust gas circulation piping 13, which connected to the inlet port of the ejector, by the jet flow of the fresh fuel gas fed to the nozzle, and discharges out the mixed gas of the fuel gas and the exhaust gas via a diffuser. The mixed gas is then fed to the hydrogen gas separator 4. This system does not include the circulation blower as in the embodiment of FIG. 1. This configuration saves the driving energy, reduces auxiliary loss, and improves the generation efficiency of the system.

### Embodiment 2

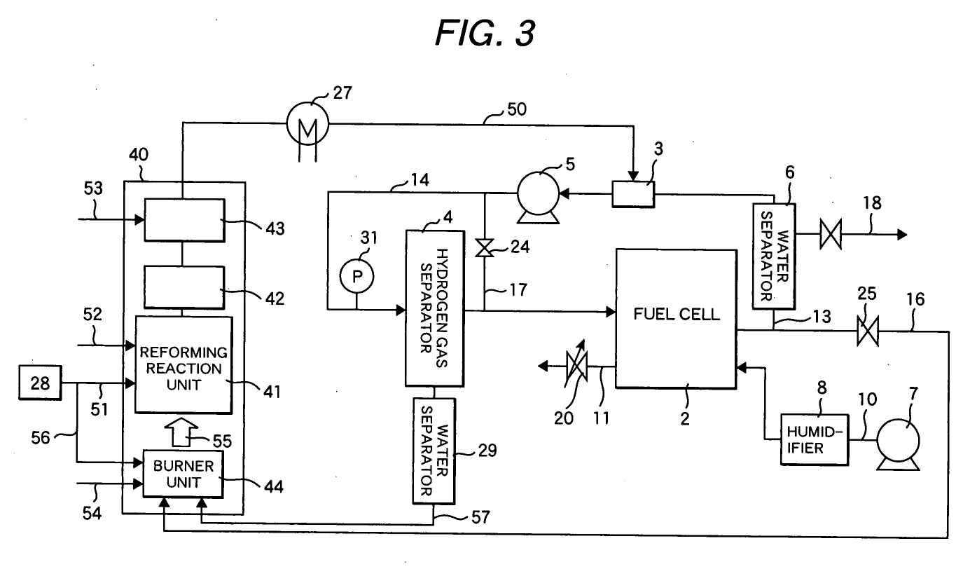

FIG. 3 illustrates another embodiment of the fuel cell power generation systems according to the present invention. The system according to the second embodiment has the same configuration and operation as the system shown in FIG. 1, except for using a reformer of a conventional external heating system as the fuel feed unit and except that the reformer herein has a different configuration. The reformer 40 comprises a reforming reaction unit 41, a carbon monoxide shift converter (CO-shift converter) 42, and a carbon monoxide-selective oxidizer 43 in this order from upstream. The reformer 40 further comprises a burner unit 44 for supplying heat necessary to the reaction to the reforming reaction unit. The reformed gas in a reformer outlet piping 50 has a hydrogen concentration of about 75% on dry basis. If the reformed gas has a high temperature, it is cooled to about 70° C. to about 90° C. in a cooler 27. The raw fuel herein is, for example, a hydrocarbon such as town gas, LPG, or natural gas; an alcohol such as methanol; or a vaporized gas of kerosene. The raw fuel is fed from a raw fuel feed unit 28 via a raw fuel feed piping 51 to the reforming reaction unit 41 of the reformer 40. The raw fuel is fed together with steam (water vapor) introduced via a steam piping 52 and produces a reformed gas mainly containing hydrogen gas as a result of a steam reforming reaction on a reforming catalyst. The reformed gas herein contains carbon monoxide (CO), carbon dioxide (CO₂), and hydrocarbons such as residual methane, in addition to hydrogen. Carbon monoxide in the reformed gas is converted to hydrogen by the action of a shift converter catalyst in the downstream CO-shift converter 42. The residual carbon monoxide in a trace amount in the reformed gas is selectively oxidized with the air by the action of a CO-selective oxidizing catalyst in a CO-selective oxidizer 43, while introducing the air via an air feed pipe 53. The carbon monoxide concentration in the reformed gas is thus preferably reduced to about 10 ppm or less. However, complete removal of carbon monoxide is difficult. If the carbon monoxide concentration increases due to decreased activity of the selective oxidizing catalyst in the CO-selective oxidizer 43 or an operation temperature shifted out of the acceptable range, the increased carbon monoxide may adversely affect the performance and operation of the fuel cell. However, the system according this embodiment has the hydrogen gas separator 4 downstream from the CO-selective oxidizer 43 so as to separate carbon monoxide from the feed gas. Thus, only a trace amount of carbon monoxide may be fed to the fuel cell 2, and this does not adversely affect the performance and stability of the cell. The system is therefore highly reliable.

The secondary gas other than hydrogen gas separated in the hydrogen gas separator 4 contains unreacted hydrocarbons that have not been converted into hydrogen by the action of the reformer 40. The secondary gas, from which water is removed in a water separator 29, is conveyed to the burner unit of the reformer 40 via a secondary gas return piping 57, is burnt by the action of the air fed via a combustion air feed pipe 54, and the heat of combustion 55 is used as part of heat source for the reforming reaction in the reforming reaction unit 41. The system may further comprise a combustion raw fuel feed piping 56 so as to use part of the raw fuel for combustion when the heat is insufficient. A residual gas is discharged from a purge piping 16 while a purge valve 25 is opened and closed so as to control the circulation flow rate and pressure of the mixed gas piping on operation startup and on operation stop. The discharged residual gas is diluted with the air and discharged from the system (not shown) or is introduced into the burner unit 44 and is discharged as burnt gas from the system, as illustrated in FIG. 3.

The system according to the second embodiment can effectively use the heat of combustion of the residual hydrocarbons and carbon monoxide contained in the secondary gas and contributes to the improvement in generation efficiency.

### Embodiment 3

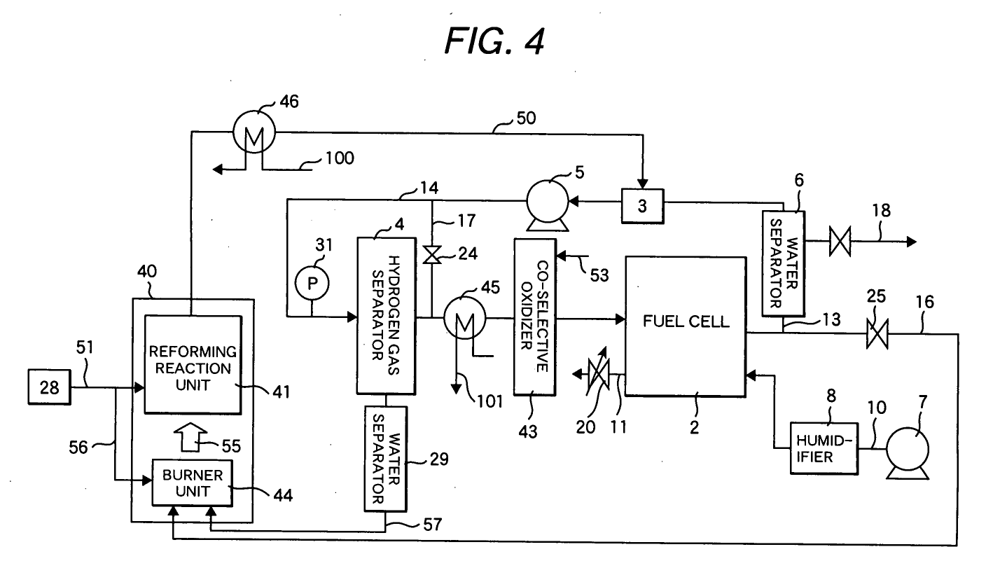

FIG. 4 shows a fuel cell power generation system according to the third embodiment of the present invention. The system has a reformer 40 which comprises only the reforming reaction unit 41 and the burner unit 44 instead of the reformer in the system according to the second embodiment (FIG. 3).

The system according to the third embodiment (FIG. 4) differ from the system according to the second embodiment (FIG. 3) in that, in addition to the configuration of the reformer 40, a CO-selective oxidizer 43 is arranged between the hydrogen gas separator 4 and the fuel cell 2, and a heat exchanger 45 for the temperature control of the CO-selective oxidizer 43 is arranged upstream from the CO-selective oxidizer 43; and that another heat exchanger 46 is arranged in the reformer outlet piping 50 between the reforming reaction unit 41 and the mixer 3. The heat exchanger 46 serves to cool the reformed gas and produce steam. The raw fuel is reformed in the reforming reaction unit 41, and the resulting reformed gas contains gases such as carbon monoxide (CO) and carbon dioxide (CO₂) in high concentrations in addition to hydrogen gas, as discussed in the second embodiment (FIG. 3). The reformed gas has a high temperature of 600° C. or higher at the outlet of the reformer 40, is cooled by the action of cooling medium 100 of the heat exchanger 46, and is conveyed to the mixer 3 via the reformer outlet piping 50. The reformed gas is then mixed with the fuel electrode exhaust gas (anode exhaust gas) conveyed into the mixer 3 via the exhaust gas circulation piping 13. The resulting mixed gas is separated into hydrogen gas and other second gas in the hydrogen gas separator 4. The cooling medium 100 herein may be water for producing steam necessary for the reforming reaction; a raw fuel which must be preheated; or the combustion air to be fed to the burner unit 44.

The hydrogen gas passed through the hydrogen separation membrane at the outlet of the hydrogen gas separator contains carbon monoxide, because the reformed gas contains carbon monoxide in a high concentration, while the concentration of carbon monoxide in the hydrogen gas varies depending on the separation performance of the hydrogen gas separator 4. Carbon monoxide should be preferably removed as far as possible, because it adversely affects the fuel cell as discussed above. The system according to the third embodiment comprises the heat exchanger 45 arranged downstream from the hydrogen gas separator 4 and the CO-selective oxidizer 43 arranged downstream from the heat exchanger 45. The system is so configured as to control the temperature of the CO-selective oxidizer 43 by flowing a cooling medium 101 and to oxidize carbon monoxide into carbon dioxide by the action of the air fed from the air feed pipe 53 to the CO-selective oxidizer 43. The secondary gas separated from hydrogen gas in the hydrogen gas separator 4, from which water is removed in a water separator 29, is conveyed to the burner unit 44 of the reformer 40 via a second gas return piping 57, is burnt by the action of the air fed through a combustion air feed pipe 54, and the heat of combustion 55 is used as part of heat source for the reforming reaction in the reforming reaction unit 41, as in the system according to the second embodiment (FIG. 3).

The system according to the third embodiment eliminates the need of a CO-shift converter necessary in conventional equivalents and eliminates the need of operation control for elevating and maintaining the temperature of the shift converter catalyst. This results in shorter time for system startup and reduced energy consumption upon startup. Thus, the generation efficiency and the reliability of the system in operation control are improved.

### Embodiment 4

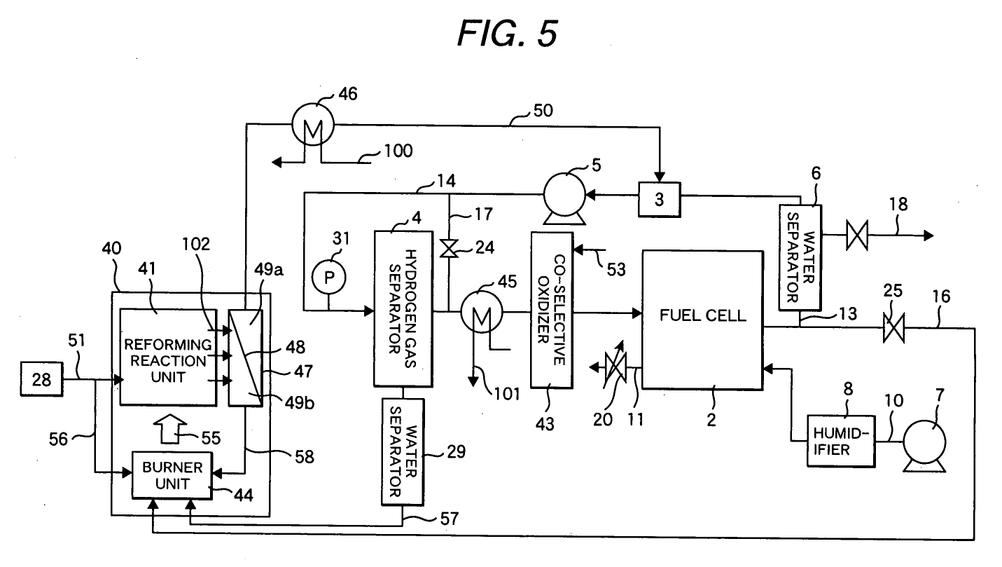

FIG. 5 shows a fuel cell power generation system as the fourth embodiment of the present invention. The system has the same configuration as the system according to the third embodiment (FIG. 4), except that the reforming reaction unit 41 in the reformer 40 has the function of hydrogen separation.

The system according to the fourth embodiment (FIG. 5) differ from the system according to the third embodiment (FIG. 4) in the following points. Specifically, the former system comprises a hydrogen separator 47 typically including a hydrogen separation membrane 48 adjacent to the reforming reaction unit 41 of the reformer 40; hydrogen 102 produced as a result of the reforming reaction sequentially permeates the adjacent hydrogen separation membrane 48 and flows into a hydrogen chamber 49a; an unpermeated gas containing combustible gas components such as residual carbon monoxide and hydrocarbons is conveyed from a residual gas chamber 49b to the burner unit 44 via a residual gas return piping 58, is burnt and is used as the heat source for the reforming reaction. The system according to the fourth embodiment comprises the reformer having the function of hydrogen separation and has a substantially equal hydrogen production quantity but shows a higher calorific value of the residual gas fed to the burner unit 44 than the system according to the second embodiment (FIG. 3) using a conventional reformer having no hydrogen separation function. The system can save the quantity of auxiliary fuel fed via the combustion raw fuel feed piping 56 to the burner unit 44 as an auxiliary heat source necessary for the reforming reaction. Thus, the efficiency of reforming process increases, and the generation efficiency further increases.

In comparison with the system according to the third embodiment (FIG. 4) using a reformer having no hydrogen separation function as in the second embodiment, the system according to the fourth embodiment has a much higher hydrogen production quantity and thereby shows a much higher generation efficiency.

### Embodiment 5

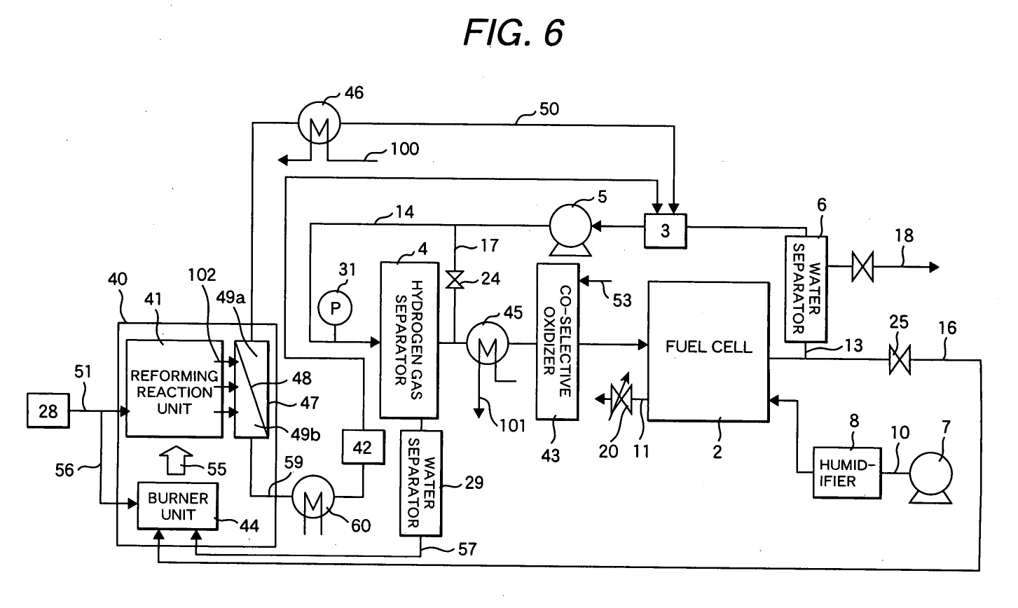

FIG. 6 shows a fuel cell power generation system according to the fifth embodiment of the present invention. In this embodiment, a reformer 40 comprises a reforming reaction unit 41 with the hydrogen separation function, as with the fourth embodiment (FIG. 5). The system according to the fifth embodiment has the same configuration as the system according to the fourth embodiment (FIG. 5), except that the system further comprises a residual gas feed piping 59 and a CO-shift converter 42 arranged on the residual gas feed piping 59. The system is so configured that a combustible gas containing combustible gas components, such as residual carbon monoxide unpermeated through the hydrogen separation membrane 48 and hydrocarbons, is fed to the CO-shift converter 42. In the CO-shift converter 42, water (H₂O) and carbon monoxide (CO) are converted into hydrogen (H₂) and carbon dioxide (CO₂) by the action of a shift conversion reaction, and the converted gas is fed to the mixer 3 via the residual gas feed piping 59. The system further comprises a cooler 60 arranged between the hydrogen separator 47. The cooler 60 controls the temperature of the residual gas (combustible gas) to an appropriate temperature to thereby carry out the shift conversion reaction in the CO-shift converter 42 appropriately. This system yields hydrogen in the largest amount among systems according to the embodiments using reformers. Thus, the system has much improved efficiency of reforming process and shows the highest generation efficiency.

### Embodiment 6

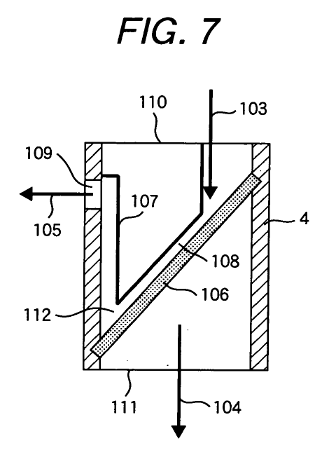

FIG. 7 schematically illustrates the configuration of a hydrogen gas separator. The hydrogen gas separator 4 illustrated in FIG. 7 as the sixth embodiment is a rectangular hydrogen gas separator, in which a mixed gas 103 of the fuel gas and the exhaust gas flows into the hydrogen gas separator 4 through an inlet 110 of the separator. A ceramic separation membrane 106 having nano-order micropores is arranged diagonally with respect to the flow of the mixed gas. The separator 4 further comprises a guide plate 107 so as to allow the mixed gas in a diagonal direction, and these components constitute a passage 108. The guide plate 107 stands vertically in the vicinity of the end portion 112 of the mixed gas flow, and the mixed gas 103 is discharged from a discharge port 109. Hydrogen in the mixed gas 103 passes through the separation membrane 106 and is discharged as a hydrogen gas 104 from a separator outlet 111.

According to the sixth embodiment, the separation membrane 106 is arranged diagonally, and the guide plate 107 is arranged so as to constitute the passage 108. This configuration increases the contact time and contact area between the separation membrane 106 and the mixed gas 103 and contributes to efficient separation of hydrogen, because the residual gas 105 can be smoothly discharged by the action of the guide plate 107.

The present invention can be applied to various fuels for use in domestic cogeneration fuel cells, and vehicle-mounted and other movable fuel cell power generation systems. Some embodiments according to the present invention can be applied to gas separators.

What is claimed is:

1. A fuel cell power generation system comprising a fuel cell being so configured as to feed a supply gas containing hydrogen gas to a fuel electrode, oxidize the supply gas, and discharge the residual gas as an exhaust gas,
wherein the supply gas comprises a mixed gas of a fuel gas containing hydrogen gas and all or part of the exhaust gas,
wherein the system further comprises a hydrogen gas separator having the function of separating hydrogen gas from the other gas, and
wherein the system is so configured as to feed the supply gas to the fuel electrode via through the hydrogen gas separator.

2. The fuel cell power generation system of claim 1, further comprising a pressure sensor arranged upstream from the hydrogen gas separator.

3. The fuel cell power generation system of claim 1, further comprising a circulation pathway and a circulation blower, the circulation pathway serving to convey the exhaust gas to the hydrogen gas separator, and the circulation blower serving to convey the mixed gas to the hydrogen gas separator.

4. The fuel cell power generation system of claim 1, further comprising a water separator having the function of separating water from a gas,
wherein the system is so configured as to allow the exhaust gas to pass through the water separator before mixing with the fuel gas.

5. The fuel cell power generation system of claim 1, further comprising a bypass for feeding the feed gas to the fuel electrode without passing through the hydrogen gas separator.

6. The fuel cell power generation system of claim 1, wherein the fuel gas is at least one selected from:
a gas containing a large amount of hydrogen gas, the hydrogen gas being derived from at least one of hydrocarbons and alcohols and being reformed by the action of a reforming catalyst in a reformer;
a gas containing a large amount of hydrogen gas, the gas being prepared by another process than reforming or derived from by-produced hydrogen, being stored in a reservoir, and being fed from the reservoir according to necessity; and
hydrogen gas being stored in and fed from a hydrogen cylinder.

7. The fuel cell power generation system of claim 1, further comprising a fuel gas feed system connecting between the hydrogen gas separator and the fuel cell; and a carbon monoxide-selective oxidizer arranged in the fuel gas feed system.

8. The fuel cell power generation system of claim 6, wherein the system is so configured as to burn a residual gas as a heat source for carrying out the reforming reaction by the action of the reforming catalyst, the residual gas being separated from hydrogen gas by the action of the hydrogen gas separator.

9. The fuel cell power generation system of claim 1, further comprising a reformer as a feed unit of the fuel gas, the reformer comprising a reforming catalyst unit having the function of separating hydrogen gas.

10. The fuel cell power generation system of claim 9, wherein the system is so configured as to burn a residual gas as a heat source for carrying out the reforming reaction by the action of the reforming catalyst, the residual gas being separated from hydrogen gas by the action of the separating hydrogen gas function in the reformer.

11. The fuel cell power generation system of claim 9, further comprising a CO-shift converter and a CO-selective oxidizer, the CO-selective oxidizer being arranged between the hydrogen gas separator and the fuel cell,
wherein the system is so configured as to allow the residual gas, which separated by the action of the separating hydrogen gas function in the reformer, to pass through the CO-shift converter, to mix a gas discharged from the CO-shift converter with a gas enriched in hydrogen gas which separated by the action of the separating hydrogen gas function in the reformer, to convey the resulting mixture to the hydrogen gas separator, and to allow the fuel gas enriched in hydrogen gas after separation to pass through the CO-selective oxidizer.

12. A method of operating a fuel cell, comprising the steps of:
mixing a fuel gas conveyed from a fuel feed unit with an exhaust gas discharged from a fuel electrode of a fuel cell;
pressurizing the resulting mixed gas and feeding the pressurized mixed gas to a unit for separating hydrogen gas; and
feeding the separated hydrogen gas to the fuel electrode of the fuel cell.

13. A method for operating a fuel cell power generation system, the fuel cell power generation system comprising a fuel feed unit; a hydrogen gas separator; and a fuel cell comprising a fuel electrode, wherein an exhaust gas from the fuel cell has an impurity gas concentration higher than that of a fuel gas fed from the fuel gas feed unit, the method comprising the steps of:
mixing the exhaust gas with the fuel gas so as to allow the resulting mixed gas to have an impurity gas concentration lower than that of the exhaust gas;
conveying the mixed gas to the hydrogen gas separator to thereby separate hydrogen gas; and
feeding the separated hydrogen gas to the fuel electrode of the fuel cell.
